(19) United States
(12) Patent Application Publication
(10) Pub. No.: US 2006/0033326 A1
(43) Pub. Date: Feb. 16, 2006

(54) Integrated greeting card and "Thank-You" note

(76) Inventors: Rosemarie R. Wilk-Orescan, Newtown, PA (US); Reza Green, Princeton, NJ (US)

Correspondence Address: Rosemarie R. Wilk-Orescan, Esq., 1 Blayze Court, Newtown, PA, 18940-1262, US

(21) Appl. No.: 11/203,028

(22) Filed: Aug. 12, 2005

Related U.S. Application Data
(60) Provisional application No. 60/601,476, filed on Aug. 13, 2004.

(51) Int. Cl. B42D 15/00

(52) U.S. Cl. 283/105

(57) ABSTRACT

This invention relates to greeting cards such as gift cards containing a “Thank-You”. More specifically, a card comprising a separate or detachable pre-printed “Thank-You” note, which the recipient of the gift can then return to the donor by postal service or other means, simultaneously extending thanks and acknowledging receipt of the gift.

### CROSS-REFERENCE TO RELATED APPLICATIONS

This application claims the benefit of U.S. Provisional Application No. 60/601,476, filed Aug. 13, 2004.

### FIELD OF THE INVENTION

This invention relates to greeting cards such as gift cards containing a “Thank-You”. More specifically, cards comprising a separate or detachable pre-printed “Thank-You” note, which the recipient of the gift can then return to the donor by postal service or other means, simultaneously extending thanks and acknowledging receipt of the gift.

### BACKGROUND OF THE INVENTION

Gift giving for such occasions as birthdays, weddings, anniversaries, baby showers, births, holidays and the like is a long-standing tradition shared by people around the world. Generally these gifts are of a material nature and are often, due to time and travel constraints, sent to the recipient, rather than presented in person by the donor. The donor in this circumstance is frustrated by not knowing the recipient has received the gift, or by not receiving acknowledgement for the gift. This is illustrated by the situation with many a grandparent who has sent gifts to the grandchildren only to never hear whether the gifts were received or enjoyed.

Another relevant circumstance is when a donor purchases a gift by telephone, internet or other means, which a third party then selects and forwards to the recipient on the donor's behalf, for example an arrangement of flowers delivered to the recipient by a florist. The present invention allows the florist to enclose a gift card with the “Thank-You” note built in. The florist would fill in the appropriate donor return address information permitting the recipient to effortlessly acknowledge receipt of the floral arrangement and simultaneously thank the donor.

Another relevant circumstance is a party to which many guests arrive bearing gifts, which often get separated from their wrappings or other indications of who brought them. The present invention allows the donor to enclose a gift card with the gift that has a “Thank-You” built in. The recipient simply returns the “Thank-You” note to the donor, thereby simultaneously extending thanks and acknowledging receipt of the gift. The present invention allows the donor to easily facilitate proper etiquette for gift recipients, especially important for children.

### BRIEF SUMMARY OF THE INVENTION

One aspect of the present invention provides a “Thank-You” note suitable for inclusion with a gift.

Another aspect of the present invention provides a greeting/gift card with an integrated “Thank-You” note.

Another aspect of the present invention provides a greeting/gift card with a detachable preprinted “Thank-You” note.

A further aspect of the present invention provides the combination of an occasion-appropriate greeting/gift card with a detachable “Thank-You” note preprinted on one face with an occasion-appropriate “Thank-You” message, having the reverse face providing an area designated for the return address of the donor.

A further aspect of the present invention is to provide a pre-printed “Thank-You” note with predetermined indicated areas on the note in which the donor can individually fill in one or more of: (i) the nature of the gift; (ii) the name of the donor; and (iii) the address of the donor to which the “Thank-You” note can be returned by mail or other means. In some embodiments, the “Thank-You” note also comprises a postage stamp or a mark indicating that the postage has been pre-paid. In some embodiments, the invention provides a separate envelope on which the address of the donor can be written (e.g., by the donor) and to which a postage stamp or pre-paid postage mark may be affixed.

In another aspect, the invention provides a method for facilitating the communication of a personalized “thank-you” by the recipient of a gift to the giver of a gift, which is carried out by providing, with a gift, a printed card with predetermined indicated regions for providing information as to one or more of: (i) the nature of the gift; (ii) the name of the donor; and (iii) the address of the donor to which the “Thank-You” note can be returned by mail or other means. In some embodiments, the address is placed on a separate envelope suitable for the “Thank-You” note that has been pre-filled by the donor. The method may further comprise affixing a stamp or other indication of pre-paid postage to the card or associated envelope.

The present invention allows the donor to easily facilitate the simultaneous extension of thanks and acknowledgment of receipt of the gift by the recipient.

### BRIEF DESCRIPTION OF THE DRAWINGS

FIG. 1 is a front perspective view of one embodiment of a greeting/gift card with detachable “Thank-You” note.

FIG. 2 is a top plane cross section view of the greeting card.

FIG. 3 is a front panel-outer surface view of the greeting card.

FIG. 4 is a front panel-inner surface view of the greeting card.

FIG. 5 is a middle panel-inner surface view of the greeting card.

FIG. 6 is a middle panel-outer surface view of the greeting card.

FIG. 7 is an end panel-inner surface view of the greeting card.

FIG. 8 is an end panel-outer surface view of the greeting card.

FIG. 9 is a back perspective view of the greeting card.

### DETAILED DESCRIPTION OF THE INVENTION

In many places, social custom dictates that a formal “thank-you” note is written by the gift recipient, placed in an envelope, addressed to the donor, stamped, and mailed. This process also serves to indicate to the donor that the recipient has actually received the gift (such as, for example, when the gift is sent by mail or delivered by a third party).

Paradoxically, the expectation of a donor that the recipient will send a “thank-you” note places a burden on the recipient of: (i) correlating the gift with the identify of the donor (which can be especially problematic during certain gift-giving occasions, such as, for example, weddings, birthdays, showers, and holidays); (ii) keeping a record of the mailing address of each donor, which may not be readily available to the gift recipient; (iii) transcribing the mailing address of the donor onto an appropriate envelope or postcard, and affixing a stamp or other indication of postage paid; (iv) writing words of thanks that are directed personally to the donor and/or reflect specifically the particular gift; and (v) mailing or returning by other means, the complete “thank-you” package.

In one series of embodiments, the invention provides a gift card assembly that comprises: (i) a gift card, optionally containing preprinted occasion-appropriate markings; (ii) a “Thank-You” note according to the invention, containing indicated areas for the donor to fill in one or more of: (a) the nature of the gift; (b) the name of the donor; and (c) the address of the donor; and (iii) a means by which the “Thank-You” note can be returned to the donor, such as, for example, by postal service.

Gift cards or gift card assemblies according to the present invention can take many forms, providing the gift card or gift assembly contains sufficient information to identify the donor and allow the recipient to return a “Thank-You” note to the donor without having to perform any action, unless so desired, other than putting a portion of the gift card, or assembly into the mail, or other delivery means. In some embodiments, one or more of elements (i)-(iii) of the gift card/gift card assembly are physically attached to, or associated with, each other. They may be detached or dissociated easily. For example, they may be attached via a perforated area that allows for easy detachment. Alternatively, one or more of the elements may be attached to one or more of the others via a non-permanent glue, such as used for Post-it® brand temporary adhesive notes (3M, St. Paul Minn.), which allows for easy detachment.

In one series of embodiments, the present invention encompasses a multiplicity of blank note cards according to the invention (in one embodiment, with predetermined areas indicated for filling in information about the gift and the identity and mailing address of the donor, but not yet filled in), which may be arrayed or reversibly attached to a larger card or other display matrix. This large card or display matrix can have occasion-appropriate shapes and designs. This display matrix may be used, for example, at a children's birthday party, baby shower, or other occasion where guests are likely to arrive bearing gifts. The guests may then be requested to fill in the necessary information on the indicated areas of a blank note and then either return the filled-in note card to the display or deposit it in another receptacle or pile. In some embodiments, the filled-in note card is returned to the display, but in a configuration in which the nature of the gift and/or the address of the donor is not visible by a casual glance, i.e. reversibly attached to the display.

In one series of embodiments, the present invention provides a note-card assembly and methods for facilitating “regifting”, a common practice in which the first recipient of a gift subsequently gives the gift to a second recipient (usually without having to unwrap and re-wrap the gift). In these embodiments, the note-card assembly of the invention comprises the following elements: (i) a first gift card, optionally containing occasion-appropriate markings; (ii) a “Thank-you” note according to the invention with pre-indicated areas in which the first donor indicates his/her name, the nature of the gift, address of the donor, and mailing means; and (iii) an additional note-card that can be filled out by the first recipient to convey the gift to a second recipient. The “regifting” card assembly, one or more of elements (i)-(iii) of the gift card/gift card assembly may be physically attached to, or associated with, each other, or may comprise distinct elements that are packaged as a unit. If they are physically attached or associated, they are preferably easily detachable.

Another embodiment of the present invention contemplates an email gift card sent to the recipient, for example as notification a gift was sent, having an email “Thank-You” note attached for detachment and return via email to the donor, or, alternatively, to be printed out and returned to the donor by postal service or other means.

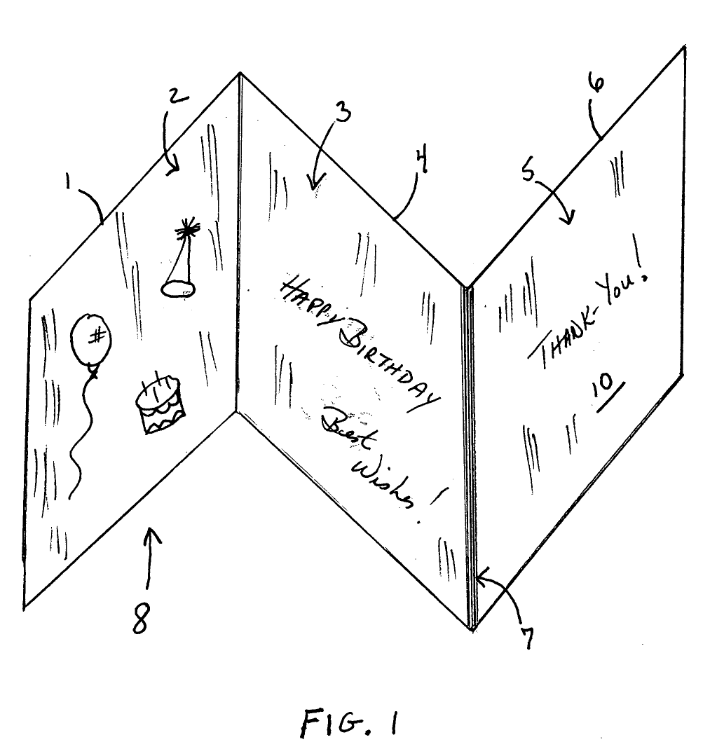

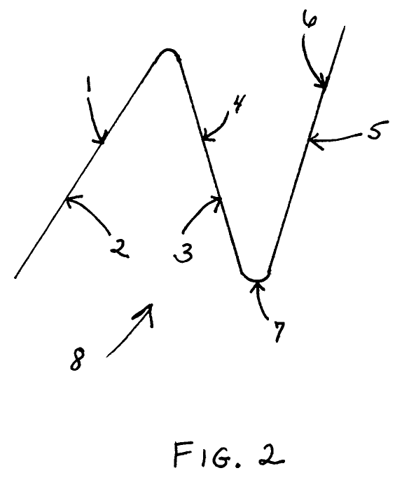

An example of one embodiment of the present invention is a greeting card 8 with detachable “Thank-You” note 10 is shown in FIGS. 1-9. The greeting card is illustrated in a square tri-panel configuration, however other embodiments can have various types of shapes and/or ornamental designs, and/or numbers of panels.

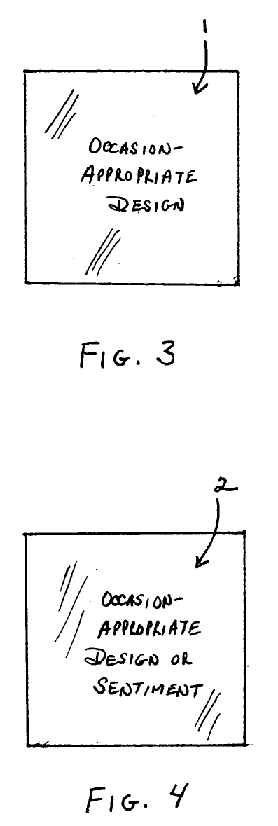

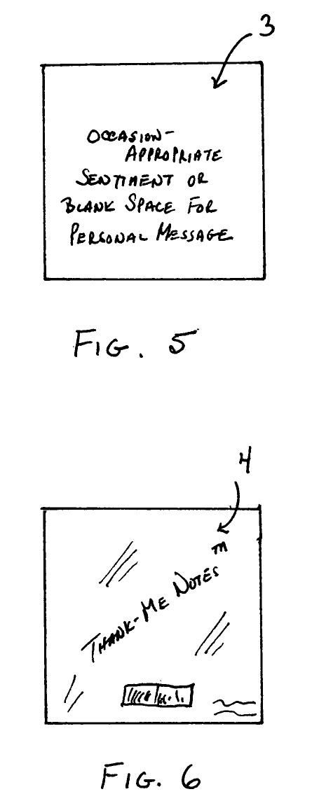

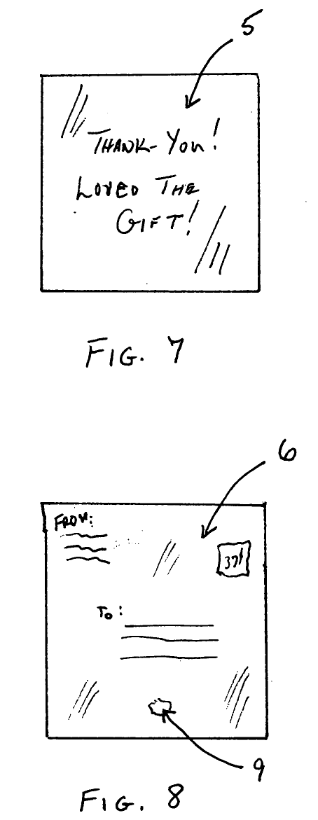

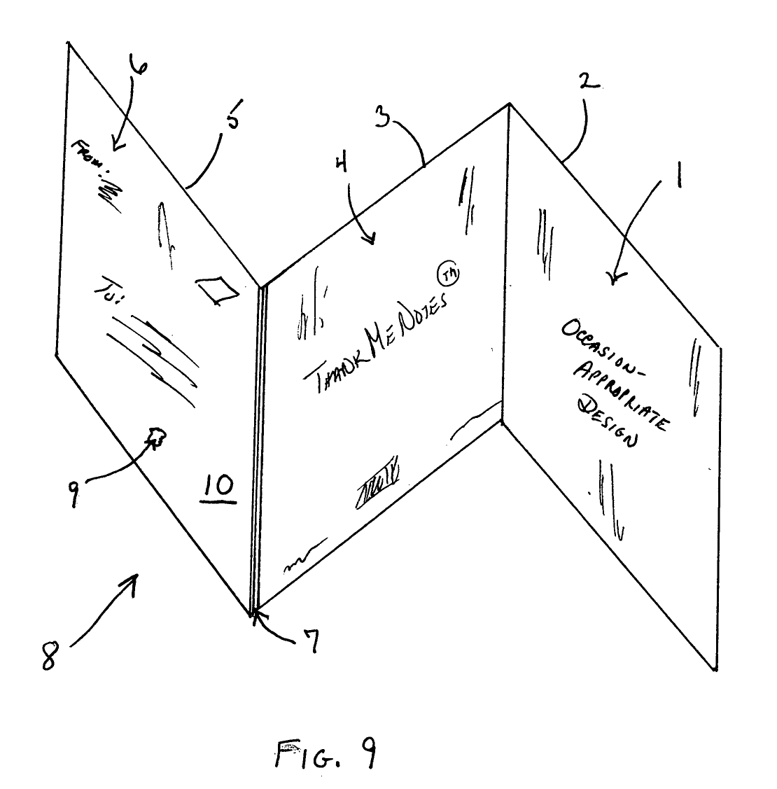

The greeting card 8, as shown in FIG. 1 and FIG. 9, includes a front panel having an outer surface 1, as shown in FIG. 3, and an inner surface 2, as shown in FIG. 4; a middle panel having an inner surface 3, as shown in FIG. 5, and an outer surface 4, as shown in FIG. 6; and a “Thank-You” note end panel 10, as shown in FIG. 1 and FIG. 9, having an inner surface 5, as shown in FIG. 7, and an outer surface 6, as shown in FIG. 8, connected to the middle panel by line of perforations 7, or other means of detachment. In one embodiment, the outer surface 6, of the “Thank-You” note end panel 10, optionally contains a small amount of temporary adhesive 9, or other means of temporary attachment of outer surface 6 to outer surface 4 to facilitate for example, display in a retail setting, or insertion into an envelope.

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted and should be read as encompassing the phrases “consisting”, “substantially comprised of,” and “consisting essentially of”.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law.

What is claimed is:

1. A note for use in conjunction with the donation of a gift by a donor to a recipient, the note comprising one or more predetermined areas suitable for indicating one or more of: (i) the nature of the gift; (ii) the name of the donor; and (iii) the address of the donor, wherein the address of the donor is positioned so that the note may be sent to the donor by postal service or other means.

2. A note as defined in claim 1, further comprising a postage stamp or pre-paid postage mark.

3. A note as defined in claim 1, further comprising a predetermined area suitable for the recipient to add personal words acknowledging the gift.

4. A greeting card for use in conjunction with the donation of a gift by a donor to a recipient, the greeting card comprising a detachably connected note containing one or more predetermined areas suitable for indicating one or more of: (i) the nature of the gift; (ii) the name of the donor; and (iii) the address of the donor, wherein the address of the donor is positioned so that the note may be sent to the donor by postal service or other means.

5. A greeting card as defined in claim 4, wherein the detachably connected note further comprises a postage stamp or pre-paid postage mark.

6. A greeting card as defined in claim 4, wherein the detachably connected note further comprises a predetermined area suitable for the recipient to add personal words acknowledging the gift.

7. A greeting card as defined in claim 4, wherein the detachably connected note is attached to the greeting card by a line of perforations along one side that is connected to the greeting card.

8. A large card or display matrix having a multiplicity of notes according to claim 1, wherein the notes are reversibly attached to the large card or display matrix.

9. A regifting card assembly comprising a first gift card, a thank-you note according to claim 1, and a second gift card.
